(19) United States
(12) Patent Application Publication
(10) Pub. No.: US 2021/0247183 A1
(43) Pub. Date: Aug. 12, 2021

(54) TYPICAL ROTATIONAL PART CHARACTERIZATION METHOD BASED ON ACTUALLY MEASURED RUN-OUT DATA

(71) Applicant: DALIAN UNIVERSITY OF TECHNOLOGY, Dalian, Liaoning (CN)

(72) Inventors: Qingchao SUN, Dalian, Liaoning (CN); Binbin ZHAO, Dalian, Liaoning (CN); Yunlong WANG, Dalian, Liaoning (CN); Liang LIU, Dalian, Liaoning (CN); Xiaokai MU, Dalian, Liaoning (CN); Kepeng SUN, Dalian, Liaoning (CN)

(21) Appl. No.: 17/052,586

(22) PCT Filed: Sep. 4, 2019
(86) PCT No.: PCT/CN2019/104273

§ 371 Date: Nov. 3, 2020

(30) Foreign Application Priority Data
Aug. 27, 2019 (CN) 201910796900.4

(51) Int. Cl. G01B 21/10; G06F 17/16

(52) U.S. Cl. CPC G01B 21/10; G06F 17/16

(57) ABSTRACT

The present invention provides a typical rotational part characterization method based on actually measured run-out data. Aiming at the characterization of rotational parts containing morphology data, the present invention proposes a matrix form characterization method in which microscopic run-out data and macroscopic axial size are comprehensively considered. In addition, the method can be applied to an assembly accuracy calculation process, and can characterize a single part containing morphology feature quantities by using only one matrix M. The calculation process of accuracy transfer is simplified, and a high-efficiency calculation model is provided for the prediction of assembly accuracy.

### TECHNICAL FIELD

The present invention relates to a characterization method for a rotational part containing interference spigots, in particular to a rotational part characterization method based on actually measured mating face run-out data.

### BACKGROUND

Rotational parts are typical parts in rotating machines such as wind power equipment and engine rotors. Since the mating face of a rotational part is not an ideal plane, but a surface with certain morphology features, when assembling the rotational part, if the influence of the morphology features of the mating faces is not considered, a certain deviation will be caused between the predicted value and the true value of assembly accuracy, making it impossible to guarantee the product assembly quality, and even leading to product failure. Therefore, in an assembly prediction process, it is particularly important to realize accurate characterization of feature quantities of a part.

For a long time, scholars at home and abroad have carried out a lot of research on the characterization of parts with surface morphology. At present, the most common method is to use Small Displacement Torsor (SDT) to characterize each mating face of a part respectively. However, one part often has multiple mating faces, so it is necessary to use multiple SDT matrices to completely characterize the micro-morphology of all mating faces of the part. In addition, this characterization method can only realize the characterization of the micro-topography of the mating faces, and the macro-size of the part is ignored; whereas in an assembly process, the coupling between the macro-size of the part and the morphology of the mating faces will have a certain influence on the prediction of the assembly accuracy. Therefore, in order to realize accurate and high-efficiency prediction of the assembly accuracy, a characterization model of a typical rotational part that contains both micro-morphology features of mating faces and macroscopic key size is urgently needed.

To solve the above problems, the present invention starts with point cloud fitting technology and homogeneous coordinate transformation technology, and establishes a calculation model for characterizing a typical rotational part with spigots based on the actually measured run-out data of mating faces of the typical rotational part by using corresponding fitting methods to fit the actually measured run-out data of end faces and radial run-out data, extracting corresponding micro-morphology feature quantities, and combining with the nominal macro-size of the part itself.

### SUMMARY

The purpose of the present invention is to provide a typical rotational part characterization method based on actually measured run-out data, thus to realize accurate and high-efficiency prediction of the assembly accuracy subsequently.

The technical solution of the present invention is as follows:

A typical rotational part characterization method based on actually measured run-out data, comprising the following steps:

1) Measuring a mating face of a rotational part by a cylindricity measuring instrument to obtain run-out data D_{bot} of a bottom end face, radial run-out data dR_{bot} of a bottom spigot, run-out data Dₜₒₚ of a top end face, and radial run-out data dRₜₒₚ of a top spigot;

2) Processing the original run-out data obtained in step 1): since the data measured by the cylindricity measuring instrument is a vector matrix with n row(s) and 1 column, i.e., the data of each end face is an axial one-dimensional run-out value, the data at each spigot is a radial one-dimensional run-out value; and a corresponding method is used to process and obtain three-dimensional coordinate data of the mating face according to actually measured radius values r_{bot} and rₜₒₚ at the circular end faces and measured radius values R_{bot} and Rₜₒₚ at the spigots in combination with actually measured run-out data;

The processing method is as follows:

For the data of the bottom end face, letting

$$θ = {[ \frac{2 π}{n} , \frac{4 π}{n} , \frac{6 π}{n} , … , 2 π ]}^{T} ,$$

then the X and Y coordinates at a bottom end face measuring point are:

X_{Dbot(i)}=r_{bot}×cos θ₍ᵢ₎,i=1,2 . . . n−1,n

Y_{Dbot(i)}=r_{bot}×sin θ₍ᵢ₎,i=1,2 . . . n−1,n

Integrating the X and Y coordinates X_{Dbot} and Y_{Dbot} at the bottom end face measuring point and the run-out data D_{bot} of the bottom end face to obtain a processed bottom end face spatial coordinate matrix N_{bot}′, and a top end face spatial coordinate matrix Dₜₒₚ′ can be obtained in the same way.

For the radial run-out data of the bottom spigot, according to the radial run-out data dR_{bot} and the measured radius value R_{bot}, the X and Y coordinates at a bottom spigot measuring point are:

X_{Rbot(i)}=(R_{bot}+dR_{bot(i)}×cos θ₍ᵢ₎

Y_{Rbot(i)}=(R_{bot}+dR_{bot(i)}×sin θ₍ᵢ₎

Due to the spigot plays a centering role in assembly, the main concern is about the position of a circle center, so letting Z_{Rbot}=0_{n×1}; integrating the X, Y and Z coordinates X_{Rbot}, Y_{Rbot} and Z_{Rbot} at the bottom spigot run-out measuring point to obtain the processed bottom spigot face spatial coordinate matrix dR_{bot}′, and the top spigot face spatial coordinate matrix dRₜₒₚ′ can be obtained in the same way.

3) Performing least square fitting on the data obtained in step 2), and extracting the corresponding feature quantities;

The extracting method is as follows:

Fitting the processed end face data D′_{bot} and D′ₜₒₚ by a least square plane, and the equation of the fitted plane is:

Ax+By+Cz+D=0

This plane can be regarded as an ideal plane rotated by a certain angle around X axis and Y axis respectively, and the corresponding deflection angles are respectively:

$$d {θ}_{x} = - \frac{B}{C} ; d {θ}_{y} = \frac{A}{C}$$

For a typical rotational part, four deflection feature quantities can be extracted from the processed end face data, which are respectively: dθ_{x_bot}, dθ_{y_bot}, dθ_{x_top} and dθ_{y_top}.

Fitting the processed spigot face data dR′_{bot} and dR′ₜₒₚ by a least square circle, and the equation of the fitted circle is:

R²=(x−dX_{bot})²+(y−dY_{bot})²

For a typical rotational part, four eccentricity feature quantities can be extracted from the processed spigot face data, which are respectively: dX_{bot}, dY_{bot}, dXₜₒₚ and dYₜₒₚ.

Therefore, for any rotational part with spigots, the deflection feature quantities dθ_{x_bot}, dθ_{y_bot}, dθ_{x_top} and dθ_{y_top} of the top and bottom end faces and the eccentricity feature quantities dX_{bot}, dY_{bot}, dXₜₒₚ and dYₜₒₚ of the top and bottom spigots of the rotational part can be obtained by performing corresponding data processing on the actually measured run-out data of the mating faces;

4) Expressing the feature quantities of the part extracted in step 3) in a matrix form: since most spigots adopt a connection form of short spigot connection, and the spigot measuring point is very close to an adjacent end face, compared with the axial height Z of the part, the axial distance between the spigot measuring point and the adjacent end face can be ignored; therefore, the end surface morphology feature quantity and the spigot morphology feature quantity are coupled into a spatial circular plane; any rotational part with spigots will include a bottom spatial circular plane and a top spatial circular plane, as shown in FIG. 1, and the corresponding bottom circular plane and top circular plane are respectively expressed as:

$${P}_{b o t} = [ \begin{matrix}1 & 0 & d {θ}_{y \_ bot} & d {X}_{b o t} \\ 0 & 1 & - d {θ}_{x \_ bot} & d {Y}_{b o t} \\ - d {θ}_{y \_ bot} & d {θ}_{x \_ bot} & 1 & 0 \\ 0 & 0 & 0 & 1\end{matrix} ]$$

$${P}_{t o p} = [ \begin{matrix}1 & 0 & d {θ}_{y \_ top} & d {X}_{top} \\ 0 & 1 & - d {θ}_{x \_ top} & d {Y}_{top} \\ - d {θ}_{y \_ top} & d {θ}_{x \_ top} & 1 & Z \\ 0 & 0 & 0 & 1\end{matrix} ]$$

5) Performing spatial eccentricity and deflection adjustment on the bottom circular plane of the part obtained in step 4), and the whole process is shown in FIG. 2: first adjusting the circle center of the bottom circular plane to the origin of absolute coordinates, and then adjusting the spatial deflection amount of the bottom circular plane to 0; i.e., the bottom plane is transformed from a spatial circular plane with a certain eccentricity amount and deflection amount into an ideal circular plane of which the circle center is located at the origin of absolute coordinates; the ideal circular plane can be expressed by a fourth-order unit matrix E, and the whole transformation process is:

$$i . e . : \begin{matrix}{P}_{bot} {⟶}^{T} E \\ T \times {P}_{bot} = E\end{matrix}$$

Then the top circular plane undergoes the same transformation, and the transformation process is:

$$i . e . : \begin{matrix}{P}_{top} {⟶}^{T} {P}_{top}^{′} \\ T \times {P}_{top} = {P}_{top}^{′}\end{matrix}$$

At this moment, the bottom circular plane has been transformed into an ideal circular plane, which no longer contains morphology feature quantities, and the morphology of the bottom circular plane is coupled to the top circular plane;

Letting M=Pₜₒₚ′, using a matrix M to characterize a typical rotational part that contains microscopic morphology features and macroscopic axial height, and using the matrix in subsequent assembly accuracy calculation process.

The present invention has the following beneficial effects aiming at the characterization of rotational parts containing morphology data, the present invention proposes a matrix form characterization method in which microscopic run-out data and macroscopic axial size are comprehensively considered. In addition, the method can be applied to the assembly accuracy calculation process, and can characterize a single part containing morphology feature quantities by using only one matrix M. The calculation process of accuracy transfer is simplified, and a high-efficiency calculation model is provided for the prediction of assembly accuracy.

### DESCRIPTION OF DRAWINGS

FIG. 1 is a schematic diagram of a spatial circular plane of a typical rotational part.

FIG. 2 shows a transformation process of a bottom circular plane of a part.

FIG. 3a shows actual measured run-out data of end faces of an aeroengine compressor rotor part.

FIG. 3b shows actual measured radial run-out data of spigots of an aeroengine compressor rotor part.

FIG. 4a is a least square fitting plane.

FIG. 4b is a least square fitting circle.

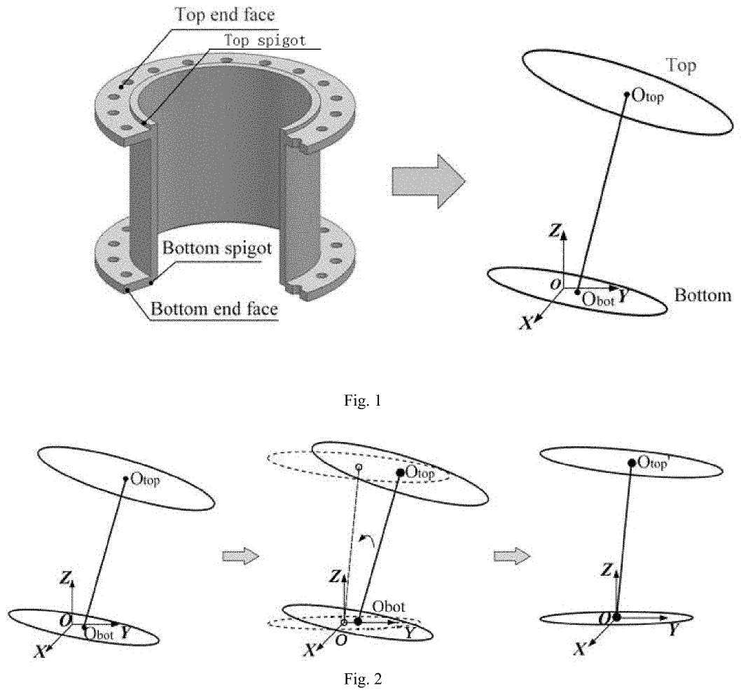

### DETAILED DESCRIPTION

To make the purpose, the technical solution and the advantages of the present invention more clear, the technical solution in the present invention will be fully described below by taking a typical rotational part (a certain type of engine rotor part) as an example in combination with the drawings of the present invention.

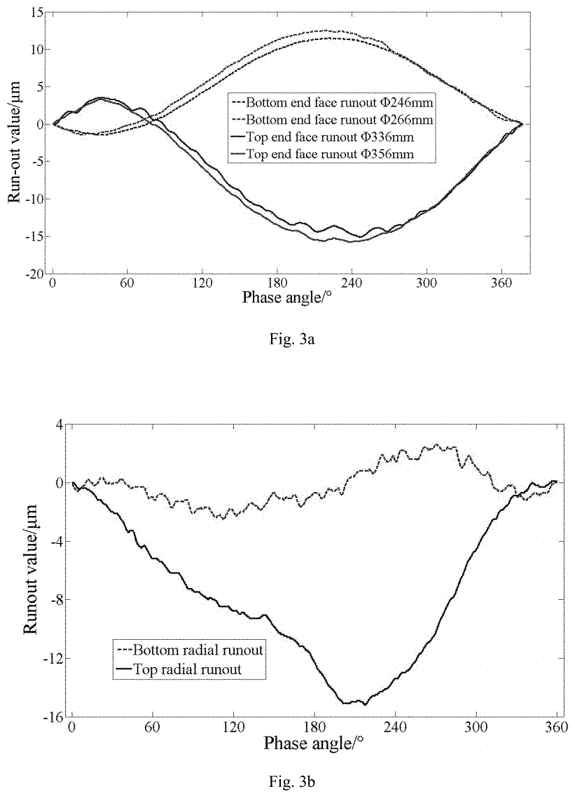

An existing iMap4 integrated measurement and assembly platform from a company is used to measure the rotor, wherein a set of inner ring run-out data and a set of outer ring run-out data are measured for each end face, and only one set of radial run-out data is measured for each spigot. The measured data is shown in FIG. 3.

The measuring point positions in a test process are: r_{bot1}=123, r_{bot2}=133, rₜₒₚ₁=168, rₜₒₚ₂=178, R_{bot}=120 and Rₜₒₚ=165. The axial height of the part is Z=120. The spatial point cloud data D_{bot_n×3} and D_{top_n×3} at the end faces and the spatial point cloud data dR_{bot_n×3} and dR_{top_n×3} at the spigots can be obtained by using the method in step 2 to process the actually measured data.

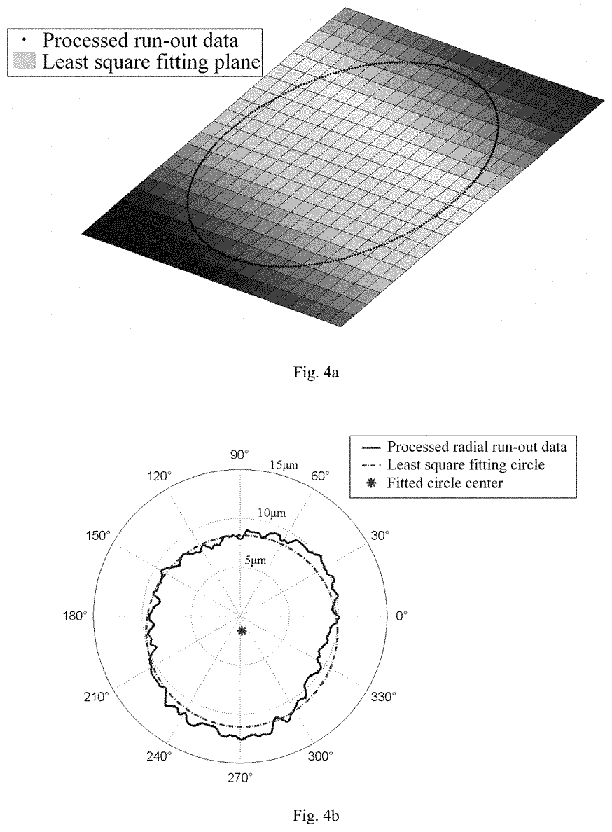

Least square plane fitting is performed on the processed spatial point cloud data at the end faces, and least square circle fitting is performed on the processed spatial point cloud data at the spigots. The fitting effect is shown in FIG. 4.

The corresponding morphology feature quantities of the mating faces can be extracted by fitting, as shown in Table 1:

| Morphology feature quantities | Value |
|---|---|
| dθₓ_{_{—}}_{bot} (10⁻⁵ rad) | 0.5129 |
| dθ_{y}_{_{—}}_{bot} (10⁻⁵ rad) | 2.0986 |
| dθₓ_{_{—}}ₜₒₚ (10⁻⁵ rad) | −1.0230 |
| dθ_{y}_{_{—}}ₜₒₚ (10⁻⁵ rad) | 1.5391 |
| dX_{bot} (10⁻⁶ m) | −4.1 |
| dY_{bot} (10⁻⁶ m) | −2.7 |
| dXₜₒₚ (10⁻⁶ m) | −2.2 |
| dYₜₒₚ (10⁻⁶ m) | 3.5 |

The morphology feature quantities in Table 1 and the axial height Z of the part are respectively substituted into the matrices P_{bot} and Pₜₒₚ to obtain the bottom circular plane matrix and the top circular plane matrix of the part.

Eccentricity and deflection adjustment is performed on the bottom circular plane by the method of matrix transformation, and a transformation matrix T=Pₙₒₜ⁻¹ of the bottom circular plane can be obtained by the method described in step 5. Multiplying the top circular plane matrix Pₜₒₚ by the matrix T, the transformed top circular plane matrix Pₜₒₚ′ can be obtained.

$${P}_{top}^{′} = [ \begin{matrix}1 & 0 & - 0.5595 {E}^{- 5} & 0.6 {E}^{- 6} \\ 0 & 1 & 1.5359 {E}^{- 5} & 6.8 {E}^{- 6} \\ 0.5595 {E}^{- 5} & - 1.5359 {E}^{- 5} & 1 & 120 \\ 0 & 0 & 0 & 1\end{matrix} ]$$

Letting M=Pₜₒₚ′, the matrix M is used to characterize the engine rotor part with the morphology features of the mating faces and the macroscopic axial size taken into consideration.

1. A typical rotational part characterization method based on actually measured run-out data, comprising the following steps:
1) measuring a mating face of a rotational part by a cylindricity measuring instrument to obtain run-out data D_{bot} of a bottom end face, radial run-out data dR_{bot} of a bottom spigot, run-out data Dₜₒₚ of a top end face, and radial run-out data dRₜₒₚ of a top spigot;
2) processing the original run-out data obtained in step 1): since the data measured by the cylindricity measuring instrument is a vector matrix with n row(s) and 1 column, i.e., the data of each end face is an axial one-dimensional run-out value, the data at each spigot is a radial one-dimensional run-out value; and a corresponding method is used to process and obtain three-dimensional coordinate data of the mating face according to actually measured radius values r_{bot} and rₜₒₚ at the circular end faces and measured radius values R_{bot} and Rₜₒₚ at the spigots in combination with actually measured run-out data;
the processing method is as follows:
for the data of the bottom end face, letting
$$θ = {[ \frac{2 π}{n} , \frac{4 π}{n} , \frac{6 π}{n} , … , 2 π ]}^{T} ,$$
then the X and Y coordinates at a bottom end face measuring point are:
X_{Dbot(i)}=r_{bot}×cos θ₍ᵢ₎i=1,2 . . . n−1,n
Y_{Dbot(i)}=r_{bot}×sin θ₍ᵢ₎i=1,2 . . . n−1,n
integrating the X and Y coordinates X_{Dbot} and Y_{Dbot} at the bottom end face measuring point and the run-out data D_{bot} of the bottom end face to obtain a processed bottom end face spatial coordinate matrix D_{bot}′, and a top end face spatial coordinate matrix Dₜₒₚ′ can be obtained in the same way;
for the radial run-out data of the bottom spigot, according to the radial run-out data dR_{bot} and the measured radius value R_{bot}, the X and Y coordinates at a bottom spigot measuring point are:
X_{Rbot(i)}=(R_{bot}+dR_{Rbot(i)})×cos θ₍ᵢ₎
Y_{Rbot(i)}=(R_{bot}+dR_{Rbot(i)})×cos θ₍ᵢ₎
due to the spigot plays a centering role in assembly, the main concern is about the position of a circle center, so letting Z_{Rbot}=0_{n×1}; integrating the X, and Z coordinates X_{Rbot}, Y_{Rbot}, and Z_{Rbot} the bottom spigot run-out measuring point to obtain the processed bottom spigot face spatial coordinate matrix dR_{bot}′, and the top spigot face spatial coordinate matrix dRₜₒₚ′ can be obtained in the same way;
3) performing least square fitting on the data obtained in step 2), and extracting the corresponding feature quantities;
the extracting method is as follows:
fitting the processed end face data D′_{bot} and D′ₜₒₚ by a least square plane, and the equation of the fitted plane is:
Ax+By+Cz+D=0
this plane can be regarded as an ideal plane rotated by a certain angle around X axis and Y axis respectively, and the corresponding deflection angles are respectively:
$$d {θ}_{x} = - \frac{B}{C} ; d {θ}_{y} = \frac{A}{C}$$
for a typical rotational part, four deflection feature quantities can be extracted from the processed end face data, which are respectively: dθ_{x bot}, dθ_{y_bot}, dθ_{x_top} and dθ_{y_top};
fitting the processed spigot face data dR′_{bot} and dR′ₜₒₚ a least square circle, and the equation of the fitted circle is:
R²=(x−dX)²+(y−dY)²
for a typical rotational part, four eccentricity feature quantities can be extracted from the processed spigot face data, which are respectively: dX_{bot}, dY_{bot}, dXₜₒₚ and dYₜₒₚ;
therefore, for any rotational part with spigots, the deflection feature quantities dθ_{x bot}, dθ_{x_bot}, dθ_{x_top} and dθ_{y_top} of the top and bottom end faces and the eccentricity feature quantities dX_{bot}d, dY_{bot}, dXₜₒₚ and dYₜₒₚ of the top and bottom spigots of the rotational part can be obtained by performing corresponding data processing on the actually measured run-out data of the mating faces;
4) expressing the feature quantities of the part extracted in step 3) in a matrix form: since most spigots adopt a connection form of short spigot connection, and the spigot measuring point is very close to an adjacent end face, compared with the axial height Z of the part, the axial distance between the spigot measuring point and the adjacent end face can be ignored; therefore, the end surface morphology feature quantity and the spigot morphology feature quantity are coupled into a spatial circular plane; any rotational part with spigots will include a bottom spatial circular plane and a top spatial circular plane, and the corresponding bottom circular plane and top circular plane are respectively expressed as:
$${P}_{b o t} = [ \begin{matrix}1 & 0 & d {θ}_{y \_ bot} & d {X}_{b o t} \\ 0 & 1 & - d {θ}_{x \_ bot} & d {Y}_{b o t} \\ - d {θ}_{y \_ bot} & d {θ}_{x \_ bot} & 1 & 0 \\ 0 & 0 & 0 & 1\end{matrix} ]$$
$${P}_{t o p} = [ \begin{matrix}1 & 0 & d {θ}_{y \_ top} & d {X}_{top} \\ 0 & 1 & - d {θ}_{x \_ top} & d {Y}_{top} \\ - d {θ}_{y \_ top} & d {θ}_{x \_ top} & 1 & Z \\ 0 & 0 & 0 & 1\end{matrix} ]$$
5) performing spatial eccentricity and deflection adjustment on the bottom circular plane of the part obtained in step 4): first adjusting the circle center of the bottom circular plane to the origin of absolute coordinates, and then adjusting the spatial deflection amount of the bottom circular plane to 0; i.e., the bottom plane is transformed from a spatial circular plane with a certain eccentricity amount and deflection amount into an ideal circular plane of which the circle center is located at the origin of absolute coordinates; the ideal circular plane can be expressed by a fourth-order unit matrix E, and the whole transformation process is:
$$i . e . : \begin{matrix}{P}_{bot} {⟶}^{T} E \\ T \times {P}_{bot} = E\end{matrix}$$
then the top circular plane undergoes the same transformation, and the transformation process is:
$$i . e . : \begin{matrix}{P}_{top} {⟶}^{T} {P}_{top}^{′} \\ T \times {P}_{top} = {P}_{top}^{′}\end{matrix}$$
at this moment, the bottom circular plane has been transformed into an ideal circular plane, which no longer contains morphology feature quantities, and the morphology of the bottom circular plane is coupled to the top circular plane;
letting M=Fₜₒₚ′, using a matrix M to characterize a rotational part that contains microscopic morphology features and macroscopic axial height, and using the matrix in sub sequent assembly accuracy calculation process.
